(19) United States
(12) Patent Application Publication
(10) Pub. No.: US 2024/0393106 A1
(43) Pub. Date: Nov. 28, 2024

(54) METHOD AND MEASURING SYSTEM FOR THREE-DIMENSIONAL MEASURING OF OBJECTS

(71) Applicant: Carl Zeiss GOM Metrology GmbH, Braunschweig (DE)

(72) Inventors: Mladen Gomercic, Braunschweig (DE); Thorsten Bothe, Braunschweig (DE); Christian Eberl, Braunschweig (DE); Michael Jörck, Braunschweig (DE)

(21) Appl. No.: 18/793,772

(22) Filed: Aug. 3, 2024

Related U.S. Application Data
(63) Continuation of application No. PCT/EP2023/052450, filed on Feb. 1, 2023.

(30) Foreign Application Priority Data
Feb. 3, 2022 (DE) 10 2022 102 547.0

(51) Int. Cl. G01B 11/25; G01N 21/01; G01N 21/64

(52) U.S. Cl. CPC G01B 11/2513; G01N 21/64; G01N 2021/0137

(57) ABSTRACT

A method for three-dimensional measuring of objects with triangulation includes projecting light structures onto an object, capturing the light structures with optoelectronic image capture, and computer-assisted evaluation of the captured images for measuring the object. The light structures are projected in a first wavelength range and the image capture detects the wavelength range that has the intensities caused by fluorescence of the object. The wavelengths emitted from the object are filtered when the projected light structures are captured. Both the wavelength range used for projecting light structures and the wavelength range having the fluorescence are detected for the same image capture and the transmission of the wavelength range having the fluorescence is larger than the transmission of the wavelength range used for projecting light structures. Electronic or electromechanical components and components made of plastics material are measured as the objects which have a self-fluorescent surface.

### CROSS REFERENCE TO RELATED APPLICATIONS

This application is a continuation application of international patent application PCT/EP2023/052450, filed Feb. 1, 2023, designating the United States and claiming priority to German application 10 2022 102 547.0, filed Feb. 3, 2022, and the entire content of both applications is incorporated herein by reference.

### TECHNICAL FIELD

The disclosure relates to a method for three-dimensional measuring of objects using a triangulating measuring method by projecting light structures onto the object to be measured, recording the projected light structures with an optoelectronic image recording and performing a computer-assisted evaluation of the recorded images for the purpose of measuring the object, with the light structures being projected in a first wavelength range and the image recording capturing the wavelength range including the intensities caused by fluorescence of the object.

The disclosure also relates to a measuring system for three-dimensional measuring of objects with a triangulating measuring method, the measuring system having a projection unit for projecting light structures onto the object to be measured, an optoelectronic image recording unit for recording the projected light structures and an evaluation unit for performing a computer-assisted evaluation of the recorded images for the purpose of measuring the object, with the measuring system being configured to project the light structures in a first wavelength range and to capture the wavelength range including the intensities caused by fluorescence of the object during the image recording.

### BACKGROUND

The three-dimensional optical capture of an object surface with optical triangulation sensors is sufficiently well known.

In this context, lines or stripe patterns, for example, are projected onto the object to be measured, are observed at an angle by one or more cameras and are subsequently evaluated with computer assistance. The evaluation methods include, e.g., a Gray code method, phase shift methods, heterodyne methods, or light section methods.

The fundamentals and practical applications of such measuring methods are described in detail, e.g., in B. Breuckmann: “Bildverarbeitung und optische Messtechnik in der industriellen Praxis”, Franzis Verlag, 1993.

DE 37 21 247 A1 describes an arrangement for determining a surface form of objects, in particular for examining the deformation of the cornea of the eye. The arrangement includes a projection grid projected onto the surface and a reference grid arranged in a beam path of an observation and/or evaluation unit. A fluorescent layer is provided on the surface and, in the projection beam path, a bandpass filter having a pass range substantially corresponding to the excitation wavelength of the fluorescent layer is provided. A bandpass filter having a pass range substantially corresponding to the wavelength of the fluorescence radiation is arranged in the beam path of the reference grid. The separation of excitation and fluorescence light with the utilized filters is intended to ensure a high-contrast representation of the contour lines in the moiré method.

DE 10 2013 001 600 A1 describes a method and device for checking the surface of a test area by irradiating the test area with electromagnetic waves, scanning at least a portion of the test area and determining the surface properties of the test area on the basis of the luminescence effects of the irradiated test area. Surface properties can be determined on the basis of changes in the fluorescence properties of an at least partly coated test area.

DE 10 2012 100 955 A1 describes a device for capturing the three-dimensional geometry of objects, in particular teeth, having an optical apparatus with a projector for projecting a pattern, a light source and a camera, wherein the light source of the projector emits light in a projection wavelength range and the optical apparatus captures light in at least two recording wavelength ranges. The autofluorescence of teeth is exploited in this case.

US 2002/0055082 A1 describes a method and system for three-dimensional measuring of objects, the surface of which is coated with a luminescent substance in order to increase the image quality. A structured light pattern at the first wavelength is projected onto the object, and an image representation of the object with the light structure projected thereon is recorded at the second fluorescent wavelength.

### SUMMARY

It is an object of the present disclosure to provide an improved method for three-dimensional measuring of objects and a measuring system for carrying out such a method.

The object is achieved by a method and a measuring system for three-dimensional measuring of objects with a triangulating measuring method as described herein.

The three-dimensional measurement utilizing the intensities of the object to be measured, as brought about by fluorescence, can be implemented by filtering the wavelengths emanating from the object when recording the projected light structures, with both the wavelength range used for projecting light structures and the wavelength range including the fluorescence being captured for the same image recording and the transmission of the wavelength range including the fluorescence being larger than the transmission of the wavelength range used for projecting light structures. An image recording thus combines the image representation brought about by the fluorescent wavelength with the image representation of the object with light structures projected thereon, as brought about by the projected wavelength. This can achieve an image representation with sharp contours, in which disturbances due to bright spots of light occurring during the projection are reduced with the aid of mixing the wavelength ranges present in the image recording.

This can be achieved by virtue of the generic measuring system including a filter for filtering the wavelengths emanating from the object when recording the projected light structures. The filter is configured such that both the wavelength range used for projecting light structures and the wavelength range including the fluorescence are captured for the same image recording and the transmission of the wavelength range including the fluorescence is larger than the transmission of the wavelength range used for projecting light structures.

The three-dimensional measurement utilizing the intensities of the object to be measured caused by fluorescence can be implemented for electronic or electromechanical components or components made of plastics material as objects having an autofluorescent surface. This enables a reliable and high-quality optical measurement without an additional modification of the object by way of coatings that are not removable, only removable with difficulties or only removable with outlay. Hence, inherent fluorescent properties of the objects to be measured are utilized independently of whether the recording of an image includes capture of only the wavelength range including the fluorescence or the damped projection wavelength range as well. In this case, the use of the measuring system and method for three-dimensional measuring of electronic or electromechanical components as objects having electrically conductive parts coated with insulation lacquer is particularly advantageous. In that case, the components can be used for the measurement without requiring an additional coating as they are already equipped with an autofluorescent surface. The recorded images of the parts provided with an autofluorescent surface, which are coated with, e.g., insulation lacquer, are captured by filtering with a higher transmission of the wavelength range including the fluorescence and a lower transmission of the wavelength range used to project light structures. For example, this can be implemented by way of a filter disposed upstream of the image sensor or by way of filtering using computer-assisted image processing after the raw data of the recorded images have been captured by the image sensor.

Coating the electrically conductive parts with insulation lacquer leads to the emission of light by these electronic or electromechanical components due to fluorescence when light structures are projected onto these components. This is utilized when recording images in the wavelength range including the fluorescence and, in the process, filtering out the wavelength range used for the projection of the light structures. Reflections in the wavelength range used for the projection of the light structures, which make the image evaluation more difficult due to bright light spots, can be eliminated as a result. By contrast, the intensities caused by fluorescence image the electronic or electromechanical components coated with insulation lacquer with such sharp contours that this enables a three-dimensional measurement without processing of the components by temporary coating being needed to this end.

The same applies to plastics components which have a fluorescent property upon illumination in the projection wavelength range and which bring about an emission of light with sufficient luminosity intensity in a fluorescence wavelength range. For example, these can be housing parts for electronic or electromechanical components, or for example plastics covers of luminaires, colored plastics or glasses.

The method can be advantageously used for measuring electrical machines, especially rotor and/or stator windings of electrical machines.

The wavelength range used for projecting the light structures can be blocked by a filter and the fluorescence wavelengths can be passed. Such filters can be easily and reliably integrated in the optics of the at least one camera used for optoelectrical image recording of the electronic or electromechanical components while a light structure is projected onto said component. The wavelength range going beyond the fluorescence wavelength range is not blocked when a long-pass edge filter is used. However, this is irrelevant since, as a rule, the optoelectronic sensor is not sensitive anymore in the wavelength range going therebeyond or since the bothersome reflections in the projection wavelength range are not found there.

The aforementioned long-pass filtering, for example using a long-pass edge filter, or bandpass filtering adapted to the wavelength ranges of the intensities of the object caused by fluorescence is conceivable.

The wavelength range used for the projection need not be blocked completely. It is conceivable that a portion of 0.1 to 10% of this wavelength range is still passed. Thus, the image information caused by the light structure projection is maintained despite the lower luminous intensity.

Advantageously, the passed portion can be chosen such that the wavelength range used for projection and the fluorescence wavelength range have a similar brightness.

The bright spots, e.g., hot spots, which occur as a result of reflection in the wavelength range used for the projection are damped to such an extent that they do not cause a disturbance in the resultant image disadvantageous for the image evaluation for the three-dimensional measurement, for example as a result of strong brightness gradients or a dynamic range that is too large for the measuring system.

For example, the fluorescence wavelength above 500 nm can be passed. For typical insulation lacquer of electronic or electromechanical components, this entire frequency range is suitable for capturing the fluorescence caused by such an insulation lacquer.

The projection can be implemented in a visible wavelength range above 400 nm. A blue light projection in the wavelength range from 420 to 490 nm is advantageous since this wavelength range is inherently safe for the eyes.

However, a projection with green light in the wavelength range from 490 to 575 nm or a combination of at least two color spectra, such as blue and green light, blue and red light, green and red light or blue, green and red light, is also conceivable.

However, the light structures can also be projected in the ultraviolet wavelength range from 100 to 400 nm; this once again depends on the measuring of the surroundings of the specific type of object to be measured. In this case, too, the ultraviolet wavelength range can be combined with at least one color at a wavelength above 400 nm.

When recording the image, filtering can be implemented with a dielectric filter, an absorbing filter or a combination of dielectric and absorbing filter. This allows the pass properties to be optimized. An antireflection coating for the filters is advantageous with regards to capturing a measurement light portion that is as large as possible.

Advantageously, the filter can be integrated in the measuring system in exchangeable fashion in order to adapt the measuring system to the respective measurement situation by replacing the filter.

It is conceivable to apply at least one fluorescing calibration marker on or next to the object for a calibration of the measuring system with the wavelength caused by the calibration marker by fluorescence. Such a calibration marker can be a punctiform reflection source or a reflection area at a known or measurable position, with which the measuring system can be calibrated or the object can be located and/or oriented. Due to the known fluorescing properties of the calibration marker, the filter can be chosen or adapted such that it also transmits the fluorescence wavelength of the marker. What can be achieved by a fluorescing calibration marker is that the measuring system can be calibrated even without a pass potion in the projection wavelength range and/or visible wavelength range. This can reduce image disturbances during the calibration. The wavelength caused by the calibration marker fluorescence need not necessarily correspond to the fluorescence wavelength of the object to be measured. In that case, passing of the calibration marker fluorescence wavelength must be ensured during the recording of the image.

In addition to the projection unit for projecting light structures onto the object to be measured, the optoelectronic image recording unit for recording the projected light structures and the evaluation unit for performing a computer-assisted evaluation of the recorded images for the purpose of measuring the object, the measuring system for three-dimensional measuring of objects can have a measuring cell with a light-transmissive pane configured to damp the ambient light in the wavelength range including the fluorescence and/or the wavelength range used for projecting the light structures. In this case, the sensor including a projection unit and an image recording unit is arranged in the measuring cell, which may additionally also contain a measuring stage such as, e.g., a rotary plate. The sensor can be attached to a robot arranged in the measuring cell and can be guided by said robot.

### BRIEF DESCRIPTION OF THE DRAWINGS

The disclosure will now be described with reference to the drawings wherein:

FIG. 1 shows an optical measuring device having a projector and a stereo camera configured to measure stator windings of an electrical machine;

FIG. 2 shows an optical measuring device having a filter configured to pass the fluorescence wavelength range and the projection wavelength range in damped fashion; and

FIG. 3 shows a perspective view of a measuring system having a measuring cell and a robot with 3-D sensor arranged therein.

### DESCRIPTION OF EXEMPLARY EMBODIMENTS

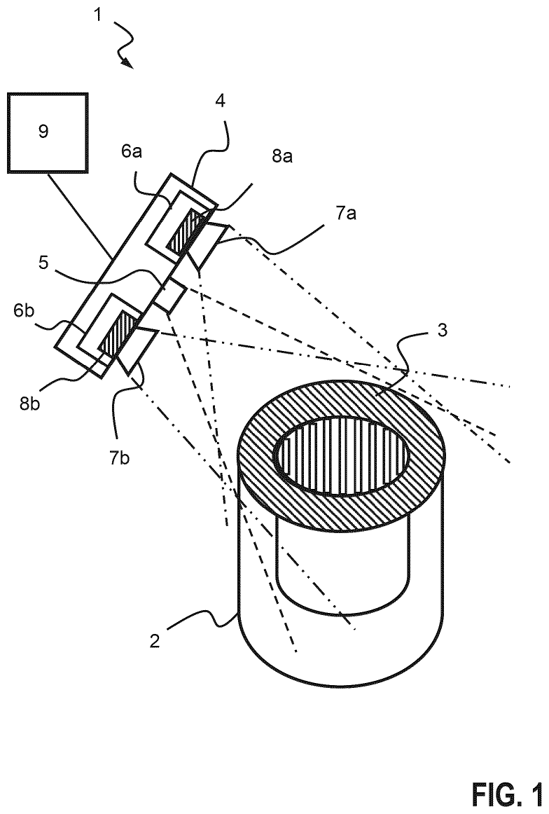

FIG. 1 shows a measuring device 1 for three-dimensional optical measuring of an object 2, which is the stator of an electrical machine in the depicted exemplary embodiment. In this case, the windings 3 which have been coated with insulation lacquer are measured optically. These insulation lacquer-coated windings 3 are electromechanical components within the meaning of the present disclosure. These windings 3 can be wound copper conductors or copper rods that have been introduced into grooves of the stator and coated with insulation lacquer, which are welded together at the head side in accordance with the respective winding layout. For example, such electromechanical components can be hairpins with a characteristic fold at the head side, corresponding to the winding layout.

A sensor head 4 (3-D sensor), formed with a projector 5 for projecting light structures onto the object 2 in a first projection wavelength range, is provided for optical measuring of such an object 2. For example, this may relate to ultraviolet and/or visible light. A structured light projection, known per se, lends itself to measuring the object 2. The projection of one or more laser lines and the like is also conceivable.

The sensor head 4 also has an image recording unit 6 with at least one camera 6a, 6b, each camera having an image sensor (not depicted here) and attached optics 7a, 7b. The cameras 6a, 6b also have a filter element 8a, 8b which filters the light incident on the optoelectronic sensor such that the wavelength range used by the projector 5 to project light structures is blocked in full or in part and a fluorescence wavelength range is passed in order to pass the light intensities caused by the fluorescence of the object 2 when light structures are projected thereon.

In this case, at least one of the filters 8a, 8b can be set such that a portion of 0.1 to 10% of the wavelength range used for the projection is passed. Hence, measurements of non-fluorescing regions of the object to be measured and of calibration markers are possible at the same time using a single image recording, i.e., using one image recording unit 6 (e.g., a camera 6a or 6b or a stereo camera 6a and 6b) and one image. Then, both the projection wavelength range and the fluorescence wavelength range are recorded using one image. As a result of damping the projection wavelength range, the amount of light is matched to the amount of light of the fluorescence wavelength range. In the case of a bright blue light of the projection, what can be achieved as a result of the portion of 0.1 to 10% is that the blue portion is adapted to have a similar brightness to the fluorescence portion of the amount of light. Hence, both filters 8a, 8b can be embodied equally for passing the fluorescence wavelength range and passing the projection wavelength range in damped fashion. It is also conceivable that one filter 8a is configured to pass the fluorescence wavelength range and the other filter 8b is configured to pass the projection wavelength range in damped fashion and that the two images recorded in different wavelength ranges by the cameras 6a, 6b are combined to form one image.

However, it is also conceivable to record images successively in time or in parallel and to subsequently combine the image recordings to form one image, wherein the wavelength range used to project light structures is blocked and the wavelength range brought about by the fluorescence is passed in one image recording and only the wavelength range used to project the light structures is captured in a second image recording.

The images captured by the image recording unit 6 including cameras 6a, 6b are supplied to an evaluation unit 9 in order to evaluate the images with computer assistance and hence measure the recorded object 2 in three dimensions.

The evaluation unit 9 can be a suitably programmed computer. In this case, the three-dimensional measurement is configured with regards to the evaluation of image information in the images obtained by the image recording in the fluorescence wavelength range. Additionally, image information contained in the image including image information in the fluorescence wavelength range can also be used in the first projection wavelength range used for the projection.

The at least one filter element 8a, 8b can be part of the recording optics 7a, 7b or part of the optoelectronic sensor, i.e., the recording chip. Thus, the filter element 8a, 8b can be screwed or clamped on an objective, for example, in order to form part of the recording optics 7a, 7b. Screwing or clamping would also allow simple use of filters adapted to the measurement situation, for example different fluorescence wavelengths.

However, it is also conceivable that the at least one filter 8a, 8b for the computer-assisted image data processing is downstream of the recording chip. However, this assumes that the image information captured by the recording chip allows a separation of the wavelength ranges. As a rule, this will require the recording chip to have special upstream filter arrays in order to be able to assign the respective wavelength ranges to individual pixels. The pixel arrays recorded thus by the recording chip are then usually post-processed by a demosaicking method in order to ensure the required resolution.

The sensor head 4 can be configured for light structure projection in the blue wavelength range above 400 nm. This leads to a more reliable illumination with sufficient fluorescence of the insulation protection lacquer.

A projection with ultraviolet light can lead to a higher light yield due to fluorescence. The projection of light structures in the green wavelength range from 490 to 575 nm is suitable, for example in the case of insulation protection lacquer, in order to image precisely capturable structures in one image, in which the fluorescence wavelength range and a portion of the projection wavelength range are captured.

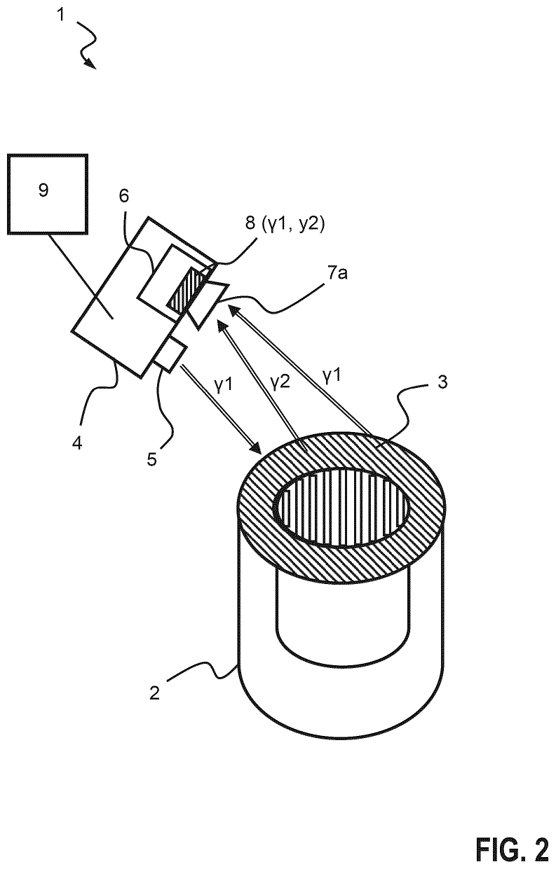

FIG. 2 shows a measuring unit 1 for three-dimensional optical measuring of an object 2, wherein a filter 8 passes a wavelength range y1, in which the projected light structure from the object 2 is recorded, and a second fluorescence wavelength range y2, in which the fluorescing surface illuminated during the projection fluoresces, to the image recording unit 6. As sketched out, the image recording unit 6 may have, for example, a camera or optionally also be configured as a stereo camera with two cameras 6a, 6b used to record an image containing image information from both wavelength ranges. However, it is also conceivable that an image is recorded by more than two cameras, the image representations from which are combined to form an image. As illustrated, the filter 8 can be configured as one filter; however, it can also be composed of a plurality of filters 8a, 8b. The filters 8 can be set such that a portion of 0.1 to 10% of the wavelength range y1 used for the projection is passed. By setting the filters 8, the brightnesses of the projection wavelength range y1 and of the fluorescence wavelength range y2 can be matched to one another such that neither of the two wavelength ranges overdetermines the image brightness. It is advantageous if the image brightnesses of the effects caused by the two wavelength ranges are approximately equal.

For example, the filter 8a can be an absorbing filter for damping the projection wavelength range and the filter 8b can be a dielectric filter for passing the fluorescence wavelength range. The pass properties can be optimized by a combination of a dielectric and absorbing filter. An antireflection coating for the filters 8, 8a, 8b is advantageous with regards to capturing a measurement light portion that is as large as possible.

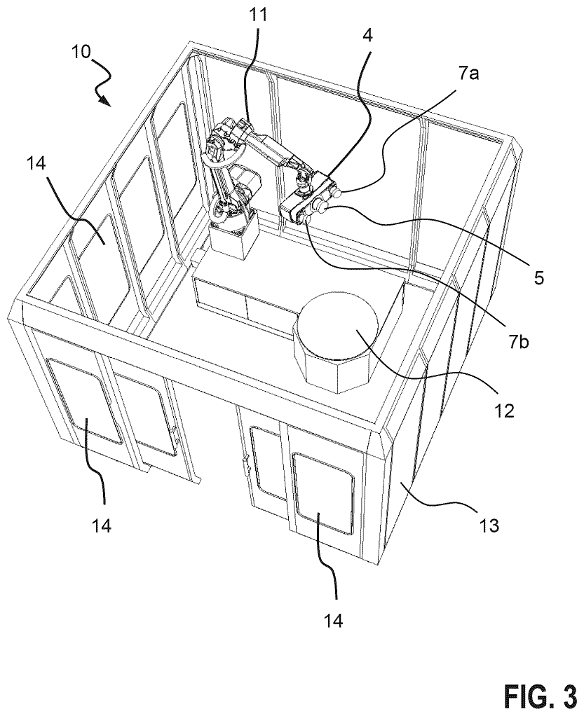

FIG. 3 shows a perspective view of a measuring system having a measuring cell 10 and a robot 11 arranged therein, the robot carrying an above-described 3-D sensor or sensor head 4. Furthermore, a measuring stage 12 is arranged in the measuring cell 10. This can be a rotary stage with a platform, on which the object 2 to be measured is placed. The object 2 can be rotated about the vertical axis of rotation, which is perpendicular to the plane of the platform, in that case. The sensor head 4 is brought into desired alignments with respect to the object 2 by the robot. The measuring stage 12 additionally allows the object 2 to be rotated, in order to also be able to measure the side rearward from the robot 11.

The measuring cell 10 has walls 13 with light-transmissive panes 14, through which ambient light can enter into the interior of the measuring cell 10. The panes 14 can be configured to damp laser light in order thus to protect persons from hazardous laser light radiation in the case of a measuring procedure with closed doors of the measuring cell 10. The panes 14 allows the measuring procedure to be observed and monitored from the outside.

In FIG. 3, the measuring cell 10 is depicted such that the ceiling is open to the top to allow identification of the interior. It is advantageous for the measuring cell 10 to have a closed ceiling in order to reduce a bothersome influence of ambient light on the optical measurement.

The ambient light can lead to problems during the measurement since the filter 8a, 8b for the image recording unit 6 significantly reduces the measurement light. The light caused by fluorescence shines less brightly than the measurement light used for the projection. It is therefore advantageous for the surroundings to be as dark as possible during the measurement. This can be ensured by managing without the panes 14 (windows), i.e., by closed walls 13. However, this is linked to the disadvantage that it is no longer that simple to observe the robot 11 and the sensor head 4 from the outside, for example for teaching and during operation.

Therefore, the panes 14 can be configured to dampen the ambient light, for example by a suitable choice of material or additionally applied filter films. In this case, the damping can be adapted to the filter 8a, 8b in order to obtain, in the wavelength range including the fluorescence, an image recording with the greatest possible light yield and a reduced influence of ambient light in this wavelength range. In an alternative to that or in addition, the adaptation can be such that the wavelength range used to project the light structures is largely blocked out of the ambient light.

What is claimed is:

1. A method for three-dimensional measuring of objects with triangulation, the method comprising:
projecting light structures onto an object to be measured;
recording the light structures with an optoelectronic image recording;
performing a computer-assisted evaluation of recorded images to measure the object, wherein the light structures are projected in a first wavelength range and the optoelectronic image recording captures a wavelength range which includes intensities caused by fluorescence of the object;
filtering wavelengths emanating from the object when recording the light structures, wherein both the wavelength range used for projecting the light structures and the wavelength range including the fluorescence are captured for a same image recording; and
matching an amount of light of a projection wavelength range passed by damping the projection wavelength range during the filtering to an amount of light at a fluorescence wavelength to equalize image brightnesses of effects caused by two wavelength ranges,
wherein a transmission of the wavelength range including the fluorescence is larger than the transmission of the wavelength range used for projecting light structures.

2. The method as claimed in claim 1, wherein autofluorescent components with an autofluorescent surface are measured as objects, and
wherein the autofluorescent components include electronic or electromechanical components and components made of plastics material.

3. A method for three-dimensional measuring of objects with a triangulating measuring method, the method comprising:
projecting light structures onto an object to be measured,
recording the light structures with an optoelectronic image recording; and
performing a computer-assisted evaluation of recorded images to measure the object,
wherein the light structures are projected in a first wavelength range and the optoelectronic image recording captures a wavelength range including intensities caused by fluorescence of the object,
wherein autofluorescent components with an autofluorescent surface are measured as objects, and
wherein the autofluorescent components include electronic or electromechanical components and components made of plastics material.

4. The method as claimed in claim 3, wherein the recorded images of the autofluorescent components are captured by filtering with a first transmission of the wavelength range including the fluorescence and a second transmission of the wavelength range used to project light structures, and
wherein the first transmission is higher than the second transmission.

5. The method as claimed in claim 2, wherein electronic or electromechanical components are coated with an insulation lacquer, and
wherein the insulation lacquer is used as the autofluorescent surface.

6. The method as claimed in claim 1, wherein the object is at least one of a rotor and stator windings of an electrical machine.

7. The method as claimed in claim 1, wherein a portion of 0.1 to 10% of the wavelength range used for projection is passed.

8. The method as claimed in claim 1, wherein a fluorescence wavelength above 500 nm is passed.

9. The method as claimed in claim 1, wherein the projecting is implemented in a visible wavelength range above 400 nm.

10. The method as claimed in claim 9, wherein the projecting is implemented with at least one of blue light in the wavelength range of 420 to 490 nm and green light in the wavelength range of 490 to 575 nm.

11. The method as claimed in claim 1, wherein the projecting is implemented in an ultraviolet wavelength range of 100 to 400 nm.

12. The method as claimed in claim 1, wherein the filtering is performed with a dielectric filter, an absorbing filter, or a combination of the dielectric and the absorbing filter.

13. The method as claimed in claim 1, wherein the filtering is performed with an antireflection coated filter.

14. The method as claimed in claim 1, wherein the filtering is performed by bandpass filtering or long-pass filtering.

15. The method as claimed in claim 1, further comprising:
applying at least one fluorescing calibration marker to the object; and
calibrating a measuring system, locating the object, and/or orienting the measuring system and the object relative to one another with the at least one fluorescing calibration marker.

16. A measuring system for three-dimensional measuring of objects with a method as claimed in claim 1, the measuring system comprising:
a projection unit configured to project the light structures onto the object to be measured;
an optoelectronic image recording unit configured to record the projected light structures;
an evaluation unit configured to perform a computer-assisted evaluation of recorded images to measure the object; and
a filter configured to filter wavelengths emanating from the object when recording the projected light structures, such that both the wavelength range used for projecting the light structures and the wavelength range including the fluorescence are captured for a same image recording and an amount of light of the projection wavelength range passed by damping the projection wavelength range during the filtering is matched to the amount of light at a fluorescence wavelength to equalize the image brightnesses of effects caused by two wavelength ranges,
wherein the measuring system is configured to project the light structures in a first wavelength range and to capture a wavelength range including intensities caused by fluorescence of the object during image recording, and
wherein a transmission of the wavelength range including the fluorescence is larger than the transmission of the wavelength range used for projecting the light structures.

17. The measuring system as claimed in claim 16, wherein the filter is at least one of dielectric, absorbing, and antireflection coated.

18. The measuring system as claimed in claim 16, wherein the filter is integrated in the measuring system in an exchangeable fashion.

19. The measuring system as claimed in claim 16, wherein the measuring system has a measuring cell with a light-transmissive pane configured to damp ambient light in the wavelength range including at least one of the fluorescence and the wavelength range used for projecting the light structures.
